(19) United States
(12) Patent Application Publication
(10) Pub. No.: US 2005/0091490 A1
(43) Pub. Date: Apr. 28, 2005

(54) Information storage server and information storage program

(75) Inventor: Kazuhiro Ogura, Yokohama-shi (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/972,647

(22) Filed: Oct. 26, 2004

(30) Foreign Application Priority Data
Oct. 27, 2003 (JP) 2003-366574

(51) Int. Cl. H04L 9/00

(52) U.S. Cl. 713/165

(57) ABSTRACT

To improve usability and convenience, there is provided an information storage server which, when providing a service of storing contents designated by a user in a content storage portion and transmitting the contents to a content output terminal in response to an output request by the user, performs authentication based on authentication information notified by the user's using a predetermined main authentication information notification function through a predetermined procedure, and provides the contents to the user via the content output terminal when an affirmative authentication result is obtained, the information storage server including a substitutive authentication reception portion which receives authentication by a substitutive authentication information notification function in which at least one of the authentication information itself and the using procedure is different from the main authentication information notification function, when the main authentication information notification function is in a unusable state.

### BACKGROUND OF THE INVENTION

1. Field of the Invention

The present invention relates to an information storage server and an information storage program, and is suitably applied to a case where contents provided from a content provider are stored in a virtual print server and are supplied to each user as needed.

2. Description of the Related Art

Conventionally, techniques described in the Japanese Patent Application Laid-Open Nos. 2003-85620 and 2002-32694 have been considered as techniques which implement measures for loss of a cash card and the like.

In the technique in the Japanese Patent Application Laid-Open No. 2003-85620, a user who knows that a cash card, passbook, credit card, or the like has been lost or stolen can operate an automatic teller machine to apply to suspend financial transactions using the cash card or the like, thereby preventing an illegal financial transaction by the third party.

In the technique in the Japanese Patent Application Laid-Open No. 2002-32694, an agent station automatically instructs to suspend use of a card based on personal card information and card company's information managed in the latest state. Thus, even when one simultaneously loses a plurality of cards due to loss of a bag or a wallet, a processing of rapidly suspending use of cards can be absolutely performed.

### SUMMARY OF THE INVENTION

However, in the techniques in the aforementioned patent literatures, it is possible to reduce a possibility that a lost cash card is illegally used by the third party, but it is impossible to receive services such as financial transactions which one could receive if he/she has the cards, and thus usability or convenience is low.

In order to solve the problem, according to a first aspect of the present invention, there is provided an information storage server (virtual print server 13, for example) which, when providing a service of storing contents designated by a user in a content storage portion and transmitting the contents to a content output terminal in response to an output request from the user, performs authentication based on authentication information notified by user's using a predetermined main authentication information notification function (non-contact IC card, password memorized by the user, or user's fingerprint, for example) through a predetermined procedure, and provides the contents to the user via the content output terminal, the information storage server comprising a substitutive authentication reception portion (substitutive authentication portion 33, for example) which receives authentication by a substitutive authentication information notification function in which at least one of the authentication information itself or the using procedure is different from the main authentication information notification function, when the main authentication information notification function is in a unusable state (a case such as loss of non-contact IC card, forgetting of memorized passwords, or injured finger).

Further, according to a second aspect of the present invention, there is provided an information storage program which, when providing a service of storing contents designated by a user in a content storage portion and transmitting the contents to a content output terminal in response to an output request from the user, performs authentication based on authentication information notified by user's using a predetermined main authentication information notification function through a predetermined procedure, and provides the contents to the user via the content output terminal when an affirmative authentication result is obtained, the information storage program causing a computer to realize a substitutive authentication reception function which receives authentication by a substitutive authentication information notification function in which at least one of the authentication information itself and the using procedure is different from the main authentication information notification function, when the main authentication information notification function is in a unusable state.

According to the present invention, usability and convenience can be enhanced.

### BRIEF DESCRIPTION OF THE DRAWINGS

FIG. 1 is a schematic diagram showing an internal constitution example of a virtual print server used in a first embodiment;

FIG. 2 is a schematic diagram showing an internal constitution example of a cellular phone and the like used in the first to third embodiments;

FIG. 3 is a schematic diagram showing an entire constitution example of a virtual print system according to the first embodiment;

FIG. 4 is an ER diagram showing a constitution example of a database used in the first embodiment;

FIG. 5 is a flowchart showing an operation example of the first to third embodiments;

FIG. 6 is a flowchart showing an operation example of the first to third embodiments;

FIG. 7 is a flowchart showing an operation example of the first to third embodiments;

FIG. 8 is a flowchart showing an operation example of the first to third embodiments;

FIG. 9 is a flowchart showing an operation example of the first to third embodiments;

FIG. 10 is a schematic diagram showing a constitution example of a display screen in the first to third embodiments;

FIG. 11 is a schematic diagram showing a constitution example of the display screen in the first to third embodiments;

FIG. 12 is a schematic diagram showing a constitution example of the display screen in the first to third embodiments;

FIG. 13 is a schematic diagram showing a constitution example of the display screen in the first to third embodiments;

FIG. 14 is a schematic diagram showing a constitution example of the display screen in the first to third embodiments;

FIG. 15 is a schematic diagram showing a constitution example of the display screen in the first to third embodiments;

FIG. 16 is a schematic diagram showing a constitution example of the display screen in the first to third embodiments;

FIG. 17 is a schematic diagram showing a constitution example of the display screen in the first to third embodiments;

FIG. 18 is a schematic diagram showing an internal constitution example of a virtual print server used in the second embodiment;

FIG. 19 is a schematic diagram showing an internal constitution example of a virtual print server used in the third embodiment;

FIG. 20 is a schematic diagram showing an entire constitution example of a virtual print system according to the second embodiment;

FIG. 21 is a schematic diagram showing a detailed constitution example of part of the virtual print server used in the second embodiment;

FIG. 22 is an ER diagram showing a constitution example of a database used in the second embodiment;

FIG. 23 is a schematic diagram showing a constitution example of a behavior list to be printed out in the second embodiment;

FIG. 24 is a schematic diagram showing a constitution example of the display screen in the second embodiment;

FIG. 25 is a flowchart showing an operation example of the second and third embodiments;

FIG. 26 is a flowchart showing an operation example of the second and third embodiments;

FIG. 27 is a flowchart showing an operation example of the second and third embodiments;

FIG. 28 is a schematic diagram showing a constitution example of the display screen in the third embodiment; and

FIG. 29 is a flowchart showing an operation example of the third embodiment.

### DESCRIPTION OF THE PREFERRED EMBODIMENTS

(A) Embodiments

Embodiments will be described below by way of example where an information storage server and an information storage program according to the present invention are applied to a virtual print system.

The virtual print system is centered on a virtual print server arranged on the Internet, and content users registered as a member in this system can utilize contents provided by a virtual print service. In the virtual print service, each content user can receive printout or screen display output of a desired image from a MMK (multimedia kiosk) terminal installed in drop-ins such as convenience stores or stations while making use of his/her own cellular phone. It is naturally possible to perform screen display output of the contents by the cellular phone instead of the MMK terminal.

The members of the virtual print server include content providers which operate a content server described later and are content providing sources in addition to the content users, but the content users are mainly targeted in the present embodiments. Hereinafter, the content user is simply denoted as “user”.
(A-1) Constitution of First Embodiment

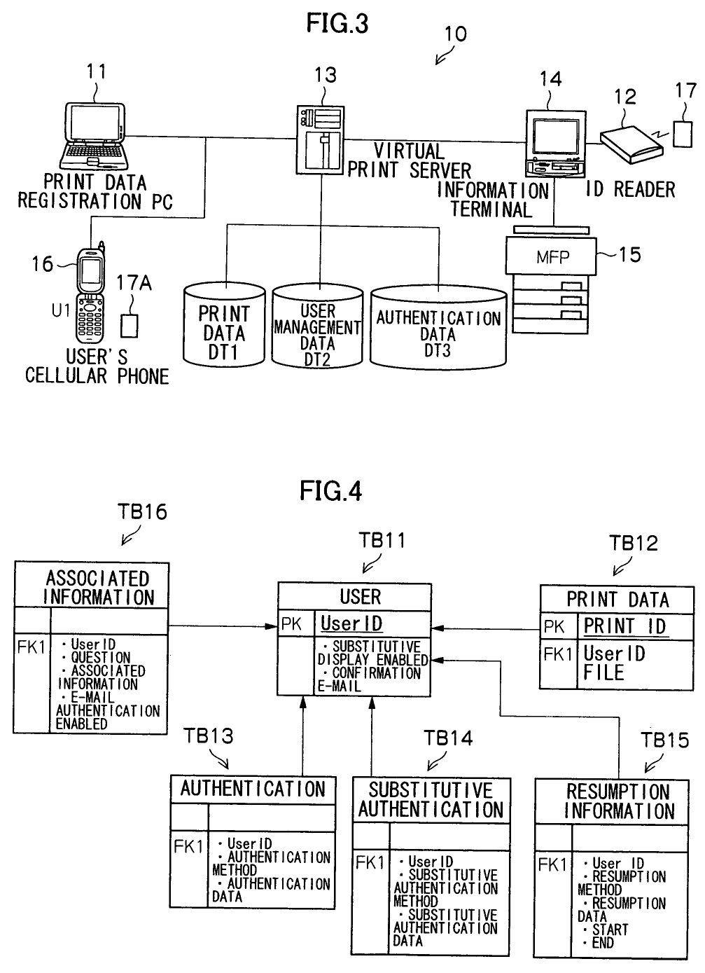

FIG. 3 shows an entire constitution example of a virtual print system 10 according to the present embodiment.

In FIG. 3, the virtual print system 10 comprises a print data registration PC (personal computer) 11, an ID reader 12, a virtual print server 13, an information terminal (MMK terminal) 14, a MFP (complex machine) 15, a cellular phone 16, an ID output device 17, and substitutive authentication means 17A.

The cellular phone 16 directly belongs to a cellular phone network operated by predetermined cellular phone companies, but can communicate with the virtual print server 13 via the cellular phone network and the Internet. The cellular phone 16 is owned and used by a user U1 which is one of the users.

Since the MMK terminals are distributed with high density at least in drop-ins in an urban district, the user U1 selects a desired MMK terminal (14, for example) among a plurality of MMK terminals present near his/her position depending on a message exchanged between the virtual print server 13 and the cellular phone 16. Further, the virtual print server 13 or the corresponding MMK terminal prepares to rapidly output (screen display or printout) contents desired by the user U1 in response to the selection, and when the user U1 actually moves to the selected MMK terminal (14, for example) to perform a predetermined operation, the image is preferably immediately output from the MMK terminal.

In the constitution of the present embodiment, the cellular phone 16 mounts thereon a Web browser, a mailer, and a camera. The Web browser is used for screen-displaying Web pages provided by a Web server in the virtual print server 13, or transmitting information input by the user U1 utilizing a screen-displayed form (a type of Web page) to the virtual print server 13.

The cameral is used for photographing a QR code (two-dimensional barcode) described later, and the mailer is used when transmitting an e-mail containing the photographing result to a corresponding e-mail address in the virtual print server 13.

The information terminal 14 is specifically the aforementioned MMK (multimedia kiosk) terminal. Only one user U1 and one MMK terminal 14 are shown in FIG. 1, but many users are generally registered in the virtual print server 13 and the users utilize the virtual print service provided by the virtual print server 13 from many MMK terminals. In order to complement the function of the cellular phone 16 whose display screen is small and which does not have a printout function and to perform screen display output or printout with sufficiently size and high accuracy near the moving destination of the user U1, thereby improving effectiveness of the virtual print service, many MMK terminals need to be distributed at high density.

Hereinafter, explanation will be made by way of example where the user U1 utilizes the MMK terminal 14.

The virtual print server 13 stores contents designated by the user U1 among contents provided by content servers (not shown) for the user U1, and transmits the stored contents and outputs (prints out or outputs on screen display) it from the MMK terminal 14 when the user U1 requests it by operating the MMK terminal 14.

Since the cellular phone 16 also mounts a function of performing screen display, when the contents are constituted in a small size (bit quantity) for the cellular phone, the contents can be displayed on the screen of the cellular phone 16. However, since the screen of the cellular phone 16 is small, in many cases, it is advantageous for the user U1 to display the contents on the larger screen of the MMK terminal 14. Further, since the cellular phone 16 does not have a printing function, the user needs to utilize the MMK terminal 14 in order to print out the contents at a desired place such as where he/she is. This is because the MMK terminal 14 comprises a printing function.

The MMK terminal itself may incorporate the printing function, but a printing function of the external MFP 15 is used in the example in FIG. 3.

The MFP 15 is an information processor which mounts thereon at least two of a copying function, a facsimile function, and a printing function. Since the copying function or the facsimile function includes a scanner function of reading arbitrary images or character strings described on a sheet, the MFP 15 also has the scanner function. All the functions of the MFP 15 may be incorporated in the MMK terminal 14 as needed.

The MMK terminal 14 is also connected at its outside with the ID reader 12.

The ID reader 12 comprises a function of supplying personal information (the virtual print server 13 performs authentication based on the personal information) acquired from the ID output device 17 by exchanging a signal with the ID output device 17 owned by the user U1 to the MMK terminal 14. The function of the ID reader 12 may be also incorporated in the MMK terminal 14.

Therefore, the ID output device 17 comprises a function of outputting the personal information of the user U1 by exchanging a signal with the ID reader 12.

The function of the ID reader 12 needs to correspond to the function of the ID output device 17.

The ID output device 17 dedicated to the virtual print service may be prepared, and a general-purpose device to be utilized for other service (credit card, for example) may be constituted to be used in the virtual print service. The ID output device 17 may employ any device which can output the personal information of the user U1 when needed so that various types of the ID output device 17 may be employed. For example, a device where a non-contact IC card has a function of outputting the personal information of the user U1 may be utilized as the ID output device 17.

The print data registration PC (personal computer) 11 is an information processor which is operated by the user U1 when storing the contents in the virtual print server 13. The contents may be selected by the user U1 in the print data registration PC 11 from among a group of contents provided by the aforementioned content servers, and may be created using the print data registration PC 11 by the user U1 or the like.

When contents to be registered in the virtual print server 13 are simply selected from among the group of contents provided by the content servers, the cellular phone 16 may be used instead of the print data registration PC 11.

An information processor other than a personal computer may be naturally used as the print data registration PC 11.

The virtual print server 13 stores various data such as print data DT1, user management data DT2, and authentication data DT3 in order to provide the membership virtual print service.

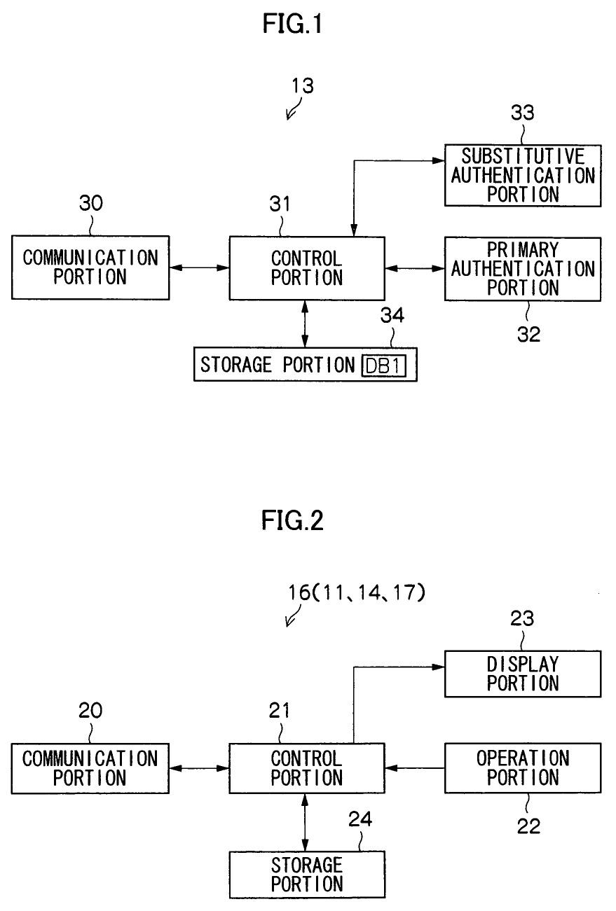

The internal constitution of the cellular phone 16 held by the user U1 is as shown in FIG. 2, for example. The internal constitutions of the MMK terminal 14, the print data registration PC 11, and the ID output device 17 maybe identical to that as far as they are shown in detail as much as illustrated. However, the MMK terminal 14 accompanies the MFP 15 as described above. When the ID output device 17 is a non-contact IC card, a user interface for the user U1 is not typically present so that an operation portion 22 and a display portion 23 described below are not required.
(A-1-1) Internal Constitution Example of Cellular Phone

In FIG. 2, the cellular phone 16 comprises a communication portion 20, a control portion 21, the operation portion 22, the display portion 23, and a storage portion 24.

The communication portion 20 functions for communication with the virtual print server 13 mainly via the Internet and the cellular phone network. Further, the communication portion 20 communicates with the content server via the Internet and the cellular phone network as needed.

When the MMK terminal 14 is assumed to be shown in FIG. 2, the communication portion 20 comprises a function of communicating with the MFP 15 or the ID reader 12 other than the virtual print server 13. When the ID output device 17 is assumed to be shown in FIG. 2, if the ID output device 17 is the non-contact IC card, the communication portion 20 makes wireless communication with the ID reader 12. This wireless communication may utilize radio waves, magnetic field, or the like.

The control portion 21 corresponds to a CPU (central processing unit) of the cellular phone 16 in hardware, and corresponds to various programs such as OS (operating system), Web browser, and mailer in software. In the present embodiment, a Web browser is basically used when contents transmitted from the virtual print server 13 are screen-displayed in the cellular phone 16, and an e-mail or Web browser is used when various notifications are exchanged with the virtual print server 13.

The operation portion 22 is operated by the user U1 who utilizes the cellular phone 16. In the case of the cellular phone, the operation portion 22 is much smaller in size and has a less number of operation keys than a keyboard of a personal computer (11, for example). However, when the MMK terminal 14 is assumed to be shown in FIG. 2, the operation portion 22 is much larger than the cellular phone and has a sufficient number of operation keys so that operability is higher than the cellular phone 16.

The display portion 23 corresponds to a display device (LCD (Liquid crystal display), for example) which displays a screen for the user U1's viewing, and constitutes the user interface together with the operation portion 22. When contents are transmitted from the virtual print server 13 to the cellular phone 16, the user U1 views the contents via the display portion 23. The screen display in the display portion 23 is performed depending on the function of the Web browser or mailer. The size of the cellular phone 16 body is smaller because of the nature of the cellular phone 16 which requires portability, and the screen size of the display portion 23 is naturally smaller than that of the personal computer (11, for example).

On the contrary, since the MMK terminal 14 is fixedly installed to be utilized and portability is not required, the screen size of the display portion 23 is much larger than that of the cellular phone 16. Therefore, even an image which is difficult to accurately display or which cannot be displayed on the cellular phone 16 because of a large number of bits can be accurately displayed on the MMK terminal 14.

The storage portion 24 is a storage resource constituted of a RAM (random access memory), a hard disk, or the like in hardware, and may contain various files in software. One example of such files is a program file such as the Web browser or mailer, or a file containing the contents so that physical entities of these files are positioned in the storage portion 24.

On the other hand, the internal constitution of the virtual print server 13 which communicates with the cellular phone 16 via the Internet and the cellular phone network may be one shown in FIG. 1, for example. The virtual print server 13 also communicates with the content server and the MMK terminal 14 other than the cellular phone 16.
(A-1-2) Internal Constitution Example of Virtual Print Server

In FIG. 1, the virtual print server 13 comprises a communication portion 30, a control portion 31, a primary authentication portion 32, a substitutive authentication portion 33, and a storage portion 34.

The communication portion 30 corresponds to the communication portion 20, the control portion 31 corresponds to the control portion 21, and the storage portion 34 corresponds to the storage portion 24, and thus detailed description thereof will be omitted.

Since the virtual print server 13 provides a server function, the control portion 31 mounts thereon various server functions such as Web server software instead of the Web browser. The control portion 31 may mount thereon a CGI program, an application program for Web service, and the like.

Furthermore, since the virtual print server 13 also communicates with the content server or the MMK terminal 14 other than the cellular phone 16, the communication portion 30 needs to correspond to such communication.

The storage portion 34 stores therein the user management data DT2 for managing registered members (U1 is one of them) by the virtual print server 13, the contents (print data) DT1 stored for each user (U1, for example), the authentication data DT3 to be used for authenticating each member, and the like.

Various data including the data DT1 to DT3 stored in the virtual print server 13 can be registered in a relational database DB1 having a constitution shown in FIG. 4. FIG. 4 is a diagram (ER diagram) corresponding to an ER model. A description by the ER model can be converted to various data models (DBMS), and FIG. 4 shows a state converted into a relational data model which is one of the data models. Therefore, in FIG. 4, a relational table is associated with each entity.

In FIG. 4, the entities (E) include associated information, user, print data, authentication, substitutive authentication, and resumption information, and an attribute is associated with each entity. Each entity can be expressed in a table (relational table) with its attributes as data items.

For example, an authentication table TB13 corresponding to the authentication which is one of the entities comprises a user ID, an authentication method, and authentication data as data items. The aforementioned authentication data DT3 corresponds to this data item “authentication data.” The user ID of the user U1 is denoted as IDU1.

In each table TB11 to TB16, FK (in this case, FK1) indicates that the data item is a foreign key (external key), and PK indicates that the data item is a primary key (main key). The main key is a data item capable of uniquely designating each row in the table. In this case, the row is directed for describing an actual value on each data item, and when each data item is horizontally arranged according to a general table expression form, one or more horizontal items registered in the table correspond to the row. The row is omitted in each table TB11 to TB16 in FIG. 4.

The external key is a data item which is a main key of other table. In FIG. 4, the user ID is assumed as the external key in all the tables TB12 to TB16 other than the table TB11.

The storage portion 34 which stores therein such a database DB1 provides various information required for performing processing by each constituent 30 to 32 in the virtual print server 13, storage areas for task, and the like.

The primary authentication portion 32 performs primary authentication (main authentication) on a user who accesses the virtual print server 13 using the cellular phone 16 or the MMK terminal 14. When performing the primary authentication, the primary authentication portion 32 follows the registration contents of the authentication table TB13.

In the primary authentication, authentication is performed based on the personal information output from the ID output device 17. The personal information may employ various information, but when a password is used as the authentication data in the authentication table TB13, for example, the personal information may be a user ID and a password.

The authentication method in the authentication table TB13 prescribes the procedure by which authentication is specifically performed using the user ID or the password. The authentication method can employ various methods, and the following procedure may be employed when using a one-time password method, for example.

In other words, when an authentication request message (the user ID is contained in this message) reaches from the ID output device 17, the virtual print server 13 generates and transmits a random number, and the ID output device 17 which receives the random number via the MMK terminal 14 or the ID reader 12 transmits a result obtained by multiplying the random number by the password. The virtual print server 13 which receives the multiplication result divides the multiplication result by the random number, and authenticates by collating the division result with the previously registered password of the user U1.

In this procedure, the multiplication result is actually transmitted between the ID reader 12 and the ID output device 17 or between the MMK terminal 14 and the virtual print server 13 (including the Internet) so that a plain text password can be prevented from tapping by the third party. A value of the random number can be changed each time the authentication message reaches.

The primary authentication portion 32 generally performs a processing corresponding to the authentication method (procedure) in the virtual print server 13.

For example, in the case of the one-time password method, the primary authentication portion 32 performs generation of the random number, division of the multiplication result, and collation between the division result and the previously registered password.

The substitutive authentication portion 33 performs substitutive authentication when the primary authentication portion 32 cannot perform general authentication. For example, when the user U1 loses the non-contact IC card (ID output device 17), the substitutive authentication needs to be performed. The substitutive authentication portion 33 performs substitutive authentication based on the registration contents of the substitutive authentication table TB14.

A constitution of the substitutive authentication table TB14 corresponds to the authentication table TB13. In other words, the user ID of the substitutive authentication table TB14 corresponds to the user ID of the authentication table TB13, the substitutive authentication method of the substitutive authentication table TB14 corresponds to the authentication method of the authentication table TB13, and the substitutive authentication data of the substitutive authentication table TB14 corresponds to the authentication data of the authentication table TB13.

As far as the substitutive authentication portion 33 performs substitutive authentication according to the registration contents of this substitutive authentication table TB14, the function of the substitutive authentication portion 33 itself basically corresponds to that of the primary authentication portion 32, but at least either one of the personal information used for authentication or the authentication method (procedure) in the substitutive authentication is different from the authentication by the primary authentication portion 32. The authentication method reflects a difference of a device used for authentication (ID output device 17, for example).

Only one substitutive authentication method may be prepared, but it is desirable that a plurality of methods are prepared to be selected by the user U1.

When performing substitutive authentication, the user U1 uses the substitutive authentication means 17A capable of outputting his/her own personal information instead of the ID output device 17.

The substitutive authentication means 17A may employ various means. For example, the substitutive authentication means 17A may preferably use an item such as employee ID card, driver's license, business card, commuter pass, resident registry card, IC card driver's license, credit card, cash card, point card, or cellular phone 16, which the user U1 always owns and which has a function of distinguishing (distinguishing function) the user U1 from other user (including other normal user or third party who tries to illegally access the virtual print server 13). A result obtained by reading an image of the employee ID card, driver's license, business card, commuter pass, and the like by a scanner of the MFP 15 are used as personal information for authenticating.

Further, since personal information can be mechanically read easily from the resident registry card, IC card driver's license, credit card, cash card, point card, and the like, they may be utilized similarly as in the ID output device 17. When a communication specification of a part corresponding to the physical layer of OSI reference model in each card is different, the ID reader 12 different for each card is generally required to prepare.

Since a recent cellular phone has many functions and possibly exercises the distinguishing function in various manners, when the cellular phone 16 mounts thereon the mailer and has a function of transmitting e-mails, for example, the source e-mail address can be used as the personal information.

Further, the substitutive authentication may employ biometrics authentication which authenticates based on physical characteristics of the user U1, and in this case, the user U1 himself/herself is the substitutive authentication means 17A. For example, the biometrics authentication may be performed based on fingerprint, facial appearance, retina pattern, voiceprint, or the like of the user U1.

When the employee ID card or driver's license contains a photograph of user U1's face, the substitutive authentication using the employee ID card or driver's license is substantially similar to the biometrics authentication using face appearance.

The exemplified substitutive authentication means has weaknesses such as low distinguishing function, relatively easy forgery, or a large amount of calculation for authentication processing, but the weaknesses can be compensated in consideration of the authentication method.

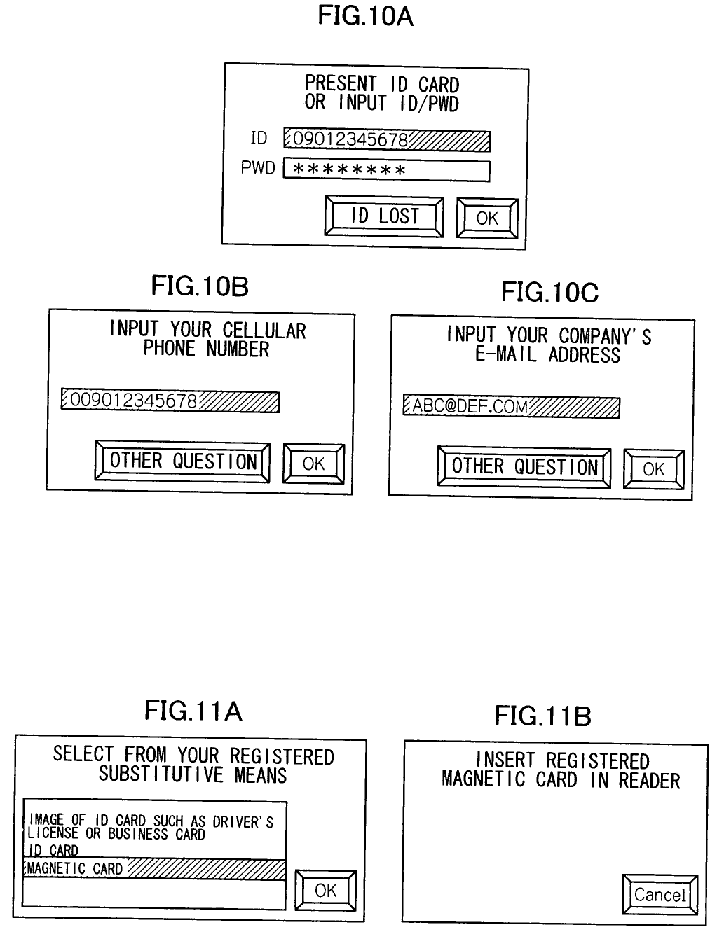

The substitutive authentication portion 33 has a function of displaying a screen in FIGS. 10A to 10C on the MMK terminal 14 and interacting with the user U1 to enable to select the substitutive authentication means desired by the user U1.

The substitutive authentication portion 33 may have a function of previously registering personal information required for the substitutive authentication in the substitutive authentication table TB14 in the virtual print server 13.

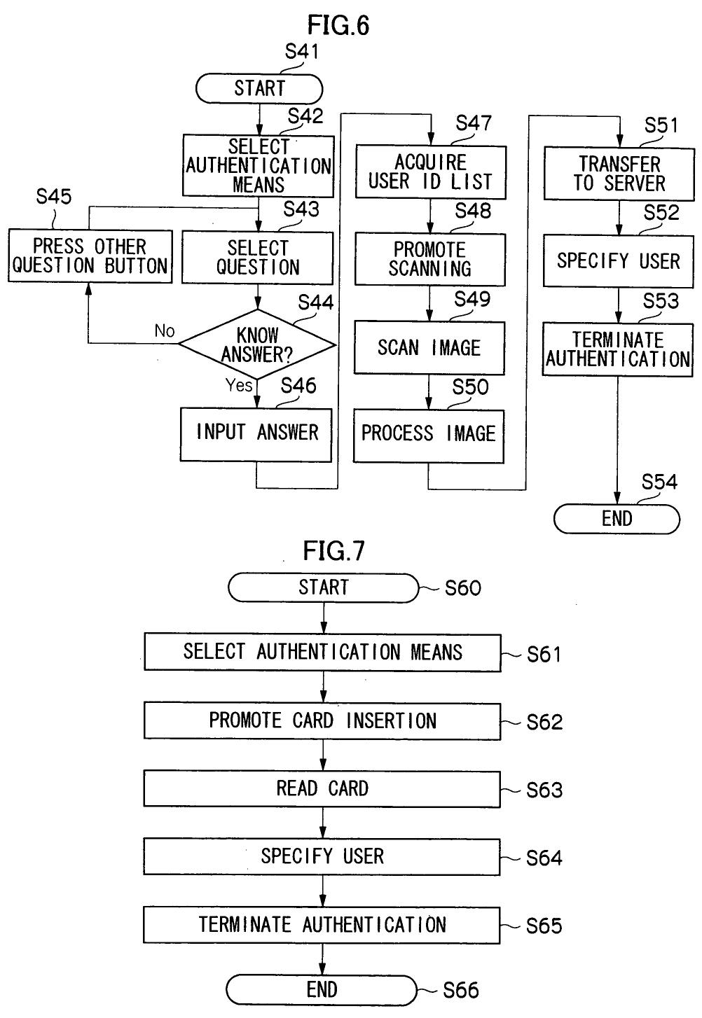

Hereinafter, an operation of the present embodiment having the above constitution will be described with reference to the flowcharts in FIGS. 6 to 9.

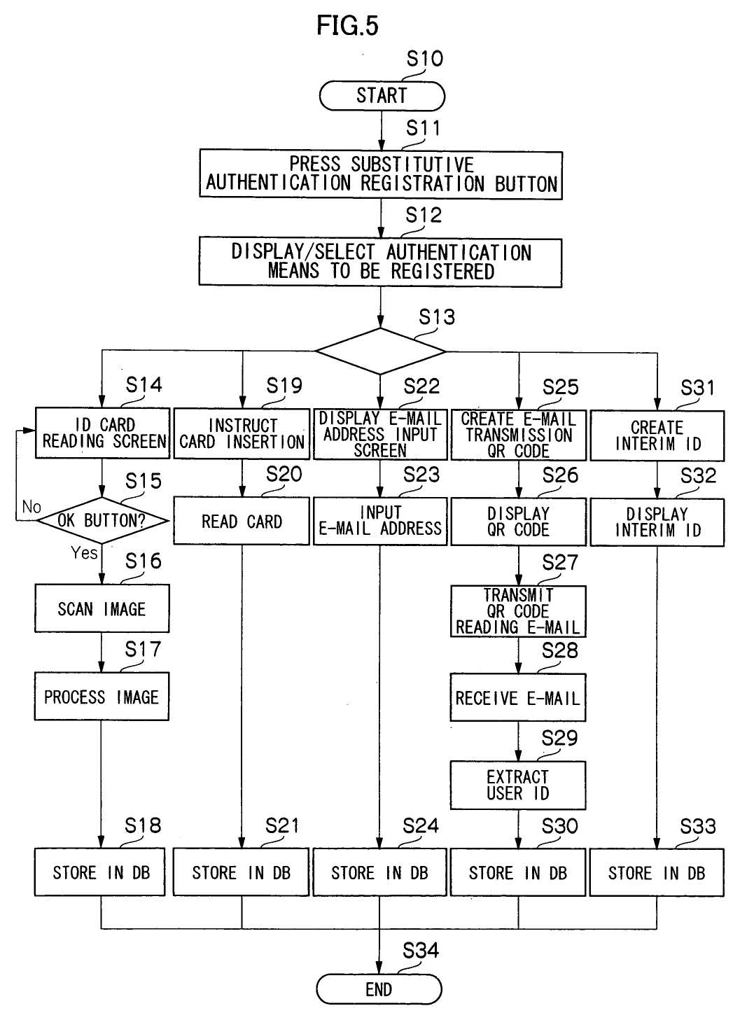

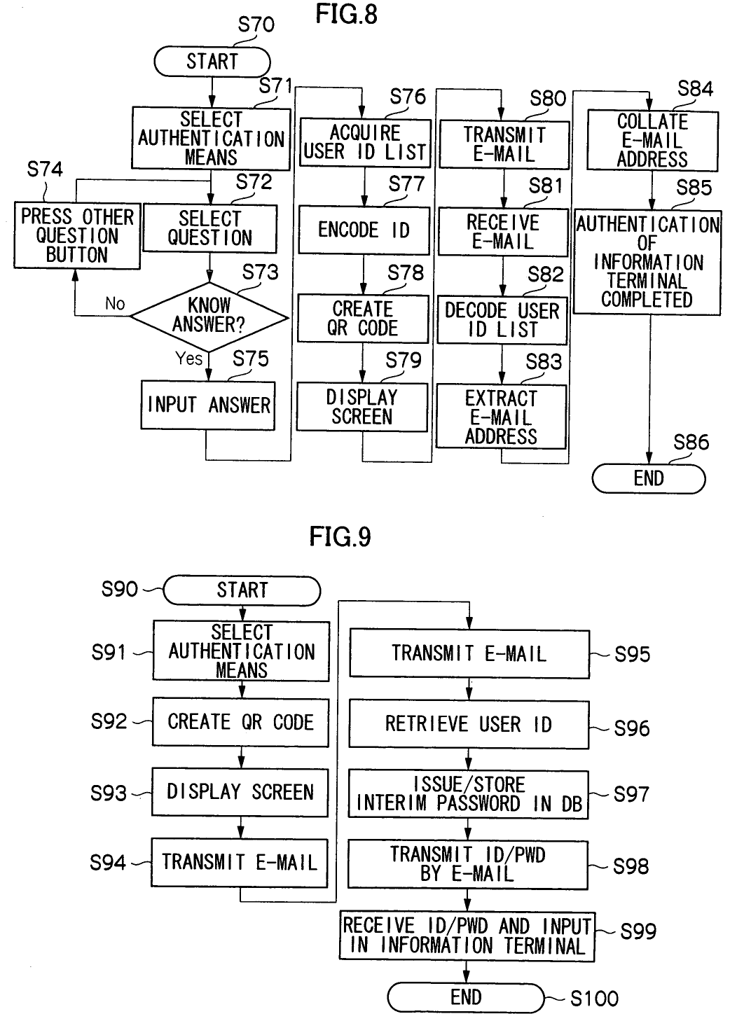

The flowchart in FIG. 5 is constituted of respective steps S10 to S34, the flowchart in FIG. 6 is constituted of respective steps S41 to S54, the flowchart in FIG. 7 is constituted of respective steps S60 to S66, the flowchart in FIG. 8 is constituted of respective steps S70 to S86, and the flowchart in FIG. 9 is constituted of respective steps S90 to S100.

The flowchart in FIG. 5 shows a flow of the processing of registering personal information (image data) for substitutive authentication in the substitutive authentication table TB14.

FIGS. 6 to 9 are the flowcharts showing a flow of the processing of using various registered personal information to perform substitutive authentication, where FIG. 6 uses image data as the personal information, FIG. 7 uses data other than the image data as the personal information (corresponding to a case such as the IC card driver's license whose personal information can be easily read), and FIGS. 8 and 9 use the source e-mail address as the personal information.
(A-2) Operation of First Embodiment

A processing of registering the image data in the employee ID card or driver's license as the personal information for substitutive authentication follows FIG. 5. When the print data registration PC 11 has a scanning function, this registration can be performed from the print data registration PC 11 and is assumed to be performed from the MMK terminal 14 in this case. The registration from the MMK terminal 14 can make use of the scanning function of the MFP 15. The virtual print server 13 can provide various Web pages to the MMK terminal 14 for this registration.

In FIG. 5, when the user U1 operates the MMK terminal 14 to screen-display the Web page provided from the virtual print server 13, a substitutive authentication registration button which requests a registration of the personal information for substitutive authentication is arranged on the Web page (screen shown in FIG. 14A, for example). When the user U1 presses this button (S10, S11), a list of the authentication means to be registered is displayed and the user U1 selects the authentication means on the screen (screen shown in FIG. 14B, for example) (S12).

In FIG. 5, step S13 is brunched into five cases depending on the selection.

Step S14 is the brunch when an ID card (such as the driver's license) is selected, step S19 is the brunch when a magnetic card or an IC card (such as the IC card driver's license) is selected, step S22 is the brunch when an e-mail is selected, step S25 is the brunch when an item utilizing the camera function of the cellular phone 16 is selected, and step S31 is the brunch when an interim ID (user ID) and an interim PWD (password) tentatively utilized only for the substitutive authentication are selected.

This selection may be exclusive to select only one authentication means, but a plurality of authentication means may be desirably selected. In any case, since it is necessary to identify for which user each authentication means is registered, it is naturally necessary to specify a user ID (IDU1, for example) of the user (U1, in this case) by inputting predetermined input columns on the Web page in the processing before step S13.

A case of the brunch in step S14 will be initially described.

In step S14, on the display portion of the MMK terminal 14, there is screen-displayed a screen containing a message which instructs the user to place an ID card on a glass surface of the MFP 15 (screen shown in FIG. 14C, for example). An OK button is also prepared on this screen, and when the user U1 places the ID card on the glass surface and presses the OK button, step S15 is brunched to Yes, the image of the ID card is read (scanned) by the scanning function of the MFP 15 to be subjected to image processing and normalized (S16, S17) so that a result of the image processing is transmitted to the virtual print server 13.

In the virtual print server 13 which has received the result, this image data is registered in a row of the user ID (IDU1) corresponding to the user U1 among the substitutive authentication data in the substitutive authentication table TB14 in a correspondence manner (S18).

In step S19, the card is inserted into the ID reader 17 to read personal information (S20), and when a communication specification of the physical layer is different for each card (the IC card driver's license), the ID reader to be inserted requires to change depending on a card to be used. A message for assisting this change may be displayed on the screen of the MMK terminal 14.

The read personal information is transmitted to the virtual print server 13 and registered as the substitutive authentication data of the substitutive authentication table TB14 similarly as in the processing after the step S14. This personal information may be a serial number of the card or a number of the credit card.

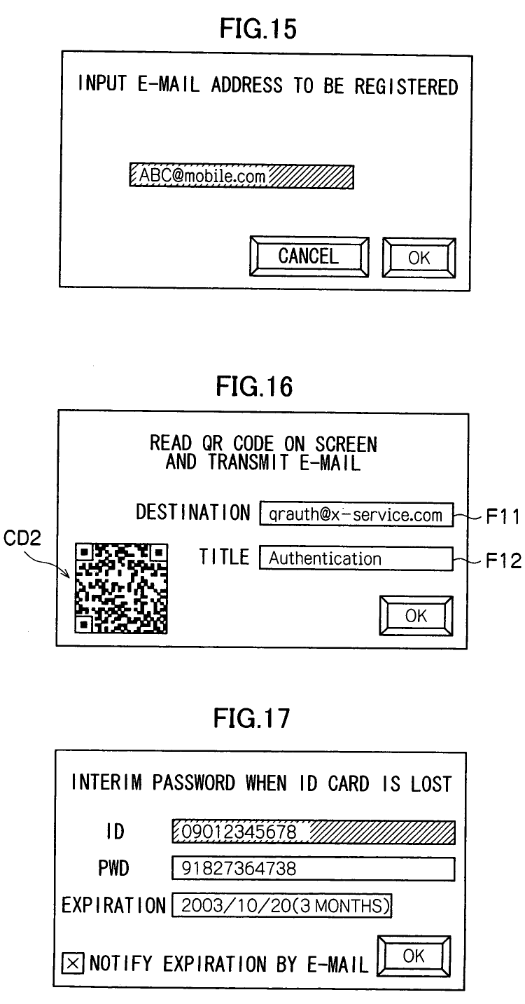

In step S22, the MMK terminal 14 is caused to screen-display a Web page containing an e-mail address input column (screen shown in FIG. 15, for example) so as to cause the user U1 to input the e-mail address (e-mail address of the cellular phone 16) (S23). The input e-mail address is registered as the substitutive authentication data in the substitutive authentication table TB14 (S24).

In step S25, a QR code for e-mail transmission is created where the encoded user ID is a text, a destination is an e-mail address for substitutive authentication means registration of the virtual print server 13, and a title is to be registered, and a Web page containing the QR code is transmitted to the MMK terminal 14 (S25). The MMK terminal 14 which receives this Web page displays a screen corresponding to the Web page (corresponding to a screen shown in FIG. 16, for example) (S26).

The user U1 who views this screen photographs the QR code on the screen by the camera of the cellular phone 16 and transmits an e-mail (S27). A destination of this e-mail is the e-mail address for substitutive authentication means registration.

When the e-mail is received (S28), the virtual print server 13 extracts the user ID and registers it in the substitutive authentication table TB14 (S29, S30).

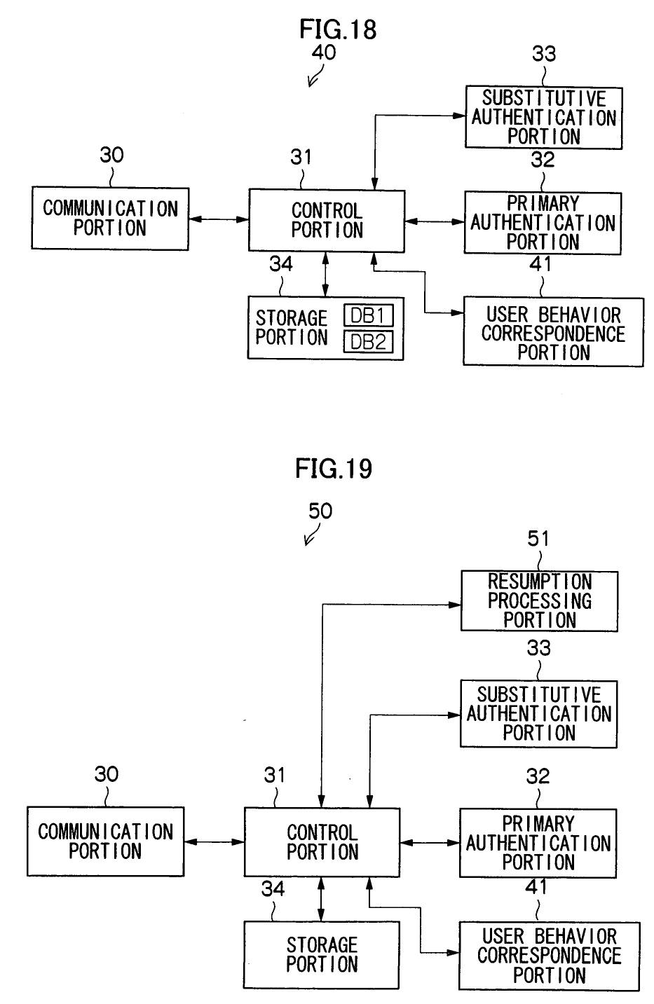

In step S31, an interim user ID or password is generated in the virtual print server 13. The contents of the generated user ID or password are displayed on the MMK terminal 14 and notified to the user U1 on a screen as shown in FIG. 17, for example (S32). FIG. 17 shows an expiration date of the interim user ID or password.

Either or both the interim user ID and password may be selected or input by the user U1 as needed.

The interim user ID and password notified to the user U1 are registered as the substitutive authentication data in the substitutive authentication table TB14 (S33).

When the registration of the substitutive authentication data has been completed, the user U1 can utilize the virtual print service through the substitutive authentication whenever necessary such as when he/she loses the ID output device 17. An effect when the result of the substitutive authentication is OK may be basically similar to an effect when a result of the primary authentication is OK, and some limitation may be imposed thereon when needed. For example, there is considered a limitation where deletion or change of the contents stored in the virtual print server 13 is not permitted.

When the user U1 can hold the ID output device 17 to perform primary authentication, the personal information is transmitted from the ID output device 17 to the virtual print server 13 and the primary authentication portion 32 in the virtual print server 13 performs primary authentication.

For example, the screen in FIG. 10A is displayed on the MMK terminal 14 to cause the user U1 to input the user ID and the password so that the primary authentication may be performed. The screen in FIG. 10A is constituted so that a Web page corresponding to the screen in FIG. 10B or 10C is provided from the virtual print server 13 when the pressing of the ID loss button by the user U1 is detected. Even when the primary authentication uses the ID output device 17, a screen provided with an interact part corresponding to the ID loss button can be displayed on the MMK terminal 14 to display the screen in FIG. 10B or 10C.

In FIG. 6, substitutive authentication by the image data is performed.

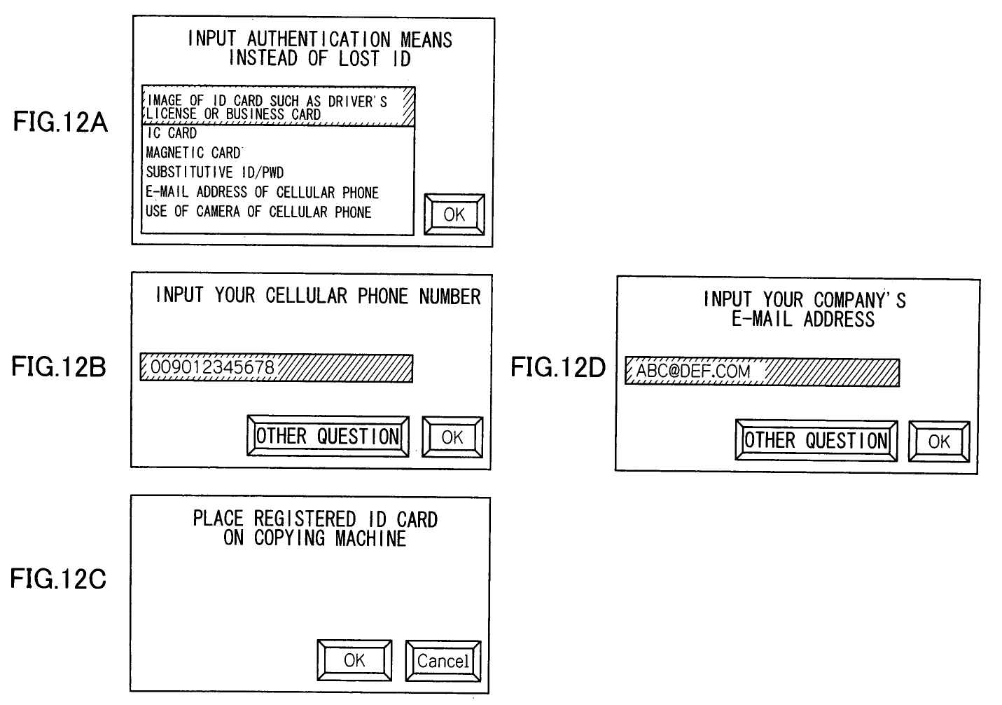

In FIG. 6, when the user U1 selects authentication means for the substitutive authentication using image data on the screen displayed on the MMK terminal 14 or shown in FIG. 12A, for example (S42), a question screen (screen in FIG. 12B or 12C, (this screen corresponds to the screen in FIG. 10B or 10C)) is displayed on the MMK terminal 14. When the user U1 does not know an answer for the question displayed on the question screen (a brunch of No in step S44), he/she presses a button for selecting other question (other question button) (S45) to reselect the question screen to be screen-displayed (the display screen on the MMK terminal 14 transits from the screen in FIG. 10B to the screen in FIG. 10C, for example, through reselection) (S43). When the user U1 knows the answer (a brunch of Yes in step S44), he/she inputs the answer for the question on the question screen (S46).

Next, the associated information table TB16 is retrieved with the question and the user U1's answer therefor as a retrieval key to specify one or more user IDs (S47). However, since a large number of users register in the virtual print server 13, one user ID cannot be specified at this stage depending on the answer and a plurality of user IDs may be retrieved.

Thereafter, the substitutive authentication portion 33 in the virtual print server 13 uses the image data registered as the personal information for the substitutive authentication (substitutive authentication data) in order to specify one user ID (IDU1, in this case) among the plurality of user IDs. Specifically, the image data includes a driver's license and the like.

The screen in FIG. 12C, for example, containing a message for promoting scanning by the MFP 15 is screen-displayed on the MMK terminal 14 in order to acquire this image data from the user (U1, for example) who tries substitutive authentication (S48). When the user U1 performs scanning in response to this message (S49), the scanned image data such as driver's license is subjected to a predetermined image processing (S50) and is then sent to the virtual print server 13 (S51). This image data is utilized by the substitutive authentication portion 33 for user (user ID) specification and substitutive authentication (S52).

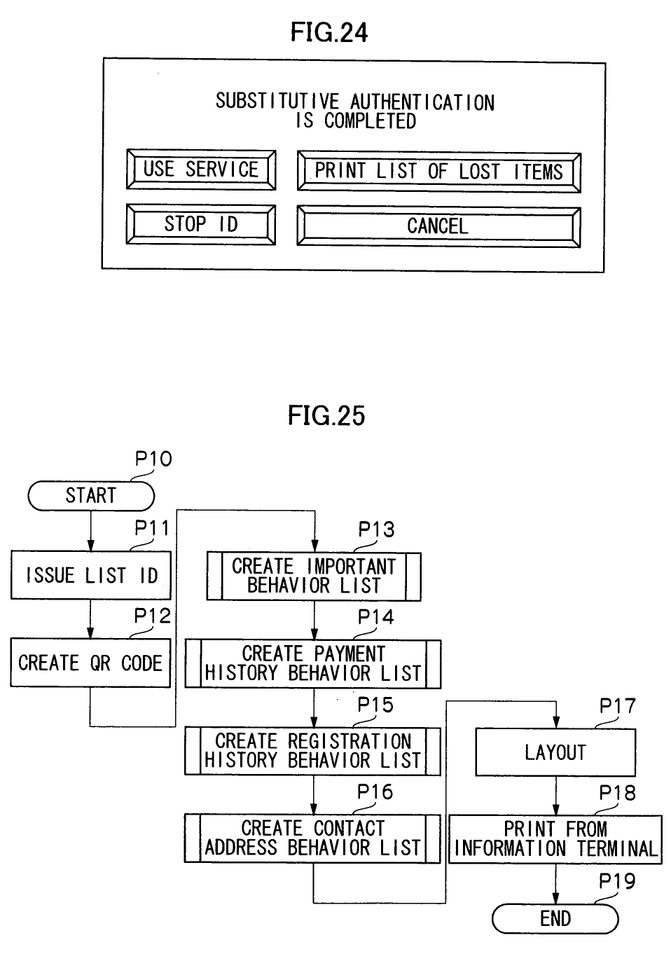

When the driver's license is previously registered as the substitutive authentication data, a result of the substitutive authentication is OK, and when not, the result is NG (S53). When the normal member of user U1 tries the authentication, the authentication result of OK can be obtained since the driver's license is the same as the previously registered one. When the authentication result of OK is obtained, a screen in FIG. 24 may be displayed on the MMK terminal 14, for example.

After the authentication result of OK is obtained, the user U1 can receive the virtual print service according to the general procedure.

When a function of identifying the image data is sufficiently high, authentication can be performed by sequentially collating the image data scanned for the authentication and sent to the virtual print server 13 with the image data previously registered in the virtual print server 13. However, since the collating of image data whose size is large and in which ambiguity easily occurs requires a large amount of calculation, the step S44 or S46 is performed to specify possible users so that the image data is collated. Thus, the calculation amount required for the authentication can be remarkably reduced.

Next, in FIG. 7, substitutive authentication is performed by data other than the image data (corresponding to a case such as the IC card driver's license whose personal information can be easily read).

In FIG. 7, step S61 corresponds to the step S42, step S64 corresponds to the step S52, and step S65 corresponds to the step S53, and thus detailed description thereof will be omitted.

A screen displayed on the MMK terminal 14 in the step S61 may be one shown in FIG. 11A, for example.

In step S62 subsequent to step S61 in FIG. 7, a screen which promotes to insert a card such as the IC card driver's license (screen in FIG. 11B, for example) is displayed on the MMK terminal 14, and in next step S63, the ID reader 12 corresponding to the card reads personal information output by the card. Thereafter, the processings in the step S64 and the like follow.

In FIGS. 8 and 9, substitutive authentication by an e-mail address is performed. FIG.8 shows a case with high security level and low convenience while FIG. 9 shows a case with low security level and high convenience.

Many steps in FIG. 8 correspond to those in FIG. 6 previously described. In other words, step S71 in FIG. 8 corresponds to the step S42, step S72 corresponds to the step S43, step S73 corresponds to the step S44, step S74 corresponds to the step S45, step S75 corresponds to the step S46, and step S76 corresponds to the step S47, and thus detailed description thereof will be omitted.

In step S77 subsequent to step S76, the substitutive authentication portion 33 in the virtual print server 13 encodes one or more user IDs specified in step S76 and converts the one or more user IDs into character strings. In this case, the user IDs may be encoded into character strings composed of only numeric characters for user U1's convenience.

Next, an e-mail transmission QR code containing the following information IT1 to IT3 is created (S78).

IT1: Authentication e-mail address of the virtual print server 13 as e-mail destination (qrauth@x-Service, for example)

IT2: E-mail title (Authentication, for example)

IT3: E-mail text

A result encoded in step S77 is used in this text.

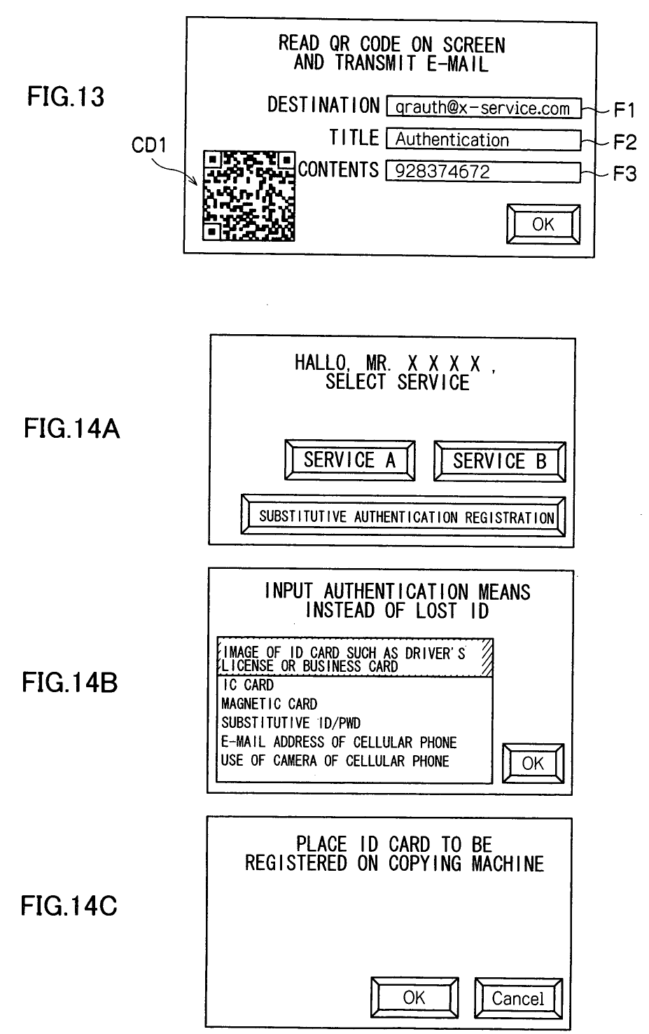

In subsequent step S79, a screen containing the created QR code is displayed on the MMK terminal 14. This screen depends on the processing in the step S73 in its contents, but may be a screen in FIG. 13 as one example.

In FIG. 13, reference symbol CD1 shows the QR code created in step S78. The description contents in the field F1 corresponds to the information IT1, the description contents in the field F2 corresponds to the information IT2, and the description contents in the field F3 corresponds to the information IT3.

Since the user U1 is operating the MMK terminal 14 while holding the camera-quipped cellular phone 16, he/she photographs the QR code CD1 by the camera according to the message displayed on the screen in FIG. 13 and transmits an e-mail from the cellular phone 16 (S80). This e-mail has a destination of the description in the field F1, a title of the description in the field F2, and the contents of the description in the field F3 on the screen in FIG. 13. The e-mail address of the cellular phone 16 which is not displayed on the screen in FIG. 13 is naturally described in the e-mail as the source e-mail address.

The e-mail transmitted from the cellular phone 16 is transmitted via the cellular phone network and the Internet and reaches the authentication e-mail address of the virtual print server 13 according to the description in the field F1 (S81).

The substitutive authentication portion 33 in the virtual print server 13 decodes and extracts one or more user IDs contained in the QR code of the e-mail (S82, S83), and collates the one or more extracted e-mail addresses with the source e-mail address of the e-mail (S84). When the processings in the steps S73 and S75 are appropriately performed and the person who has transmitted the e-mail is a normal member, the source e-mail address matches any one of the extracted one or more e-mail addresses so that the authentication result is OK, but otherwise, the authentication result is NG (S85).

Many steps in FIG. 9 correspond to the steps in FIGS. 7 and 8 previously described. In other words, step S91 in FIG. 9 corresponds to the step S61, step S92 corresponds to the step S78, step S93 corresponds to the step S79, step S94 corresponds to the step S80, and step S95 corresponds to the step S81, and thus detailed description thereof will be omitted.

In FIG. 9, the step S92 is different from the step S78 in that the created QR code does not contain the user ID.

Correspondingly, a screen displayed on the MMK terminal 14 in step S93 is one shown in FIG. 16, for example.

Therefore, in the flowchart in FIG. 9, the substitutive authentication portion 33 in the virtual print server 13 receives the e-mail from the cellular phone 16 in step S95 and then retrieves the substitutive authentication table TB14 with the source e-mail address of any e-mail as the retrieval key so that the user ID of the user U1 is specified (S96).

Subsequently, the substitutive authentication portion 33 issues the interim user ID and password for the user U1 and stores the same in the database DB1 (S97), and transmits the interim user ID and password to the cellular phone 16 by e-mail (S98).

Thereafter, the user U1 confirms the interim user ID and password on the screen of the cellular phone 16 and inputs the user ID and password in the MMK terminal 14 to request the substitutive authentication (S99). The subsequent procedure may be similar as in the authentication (primary authentication) by the general user ID and password.

Even when the user U1 cannot perform primary authentication in this manner because of loss of the ID output device 17, he/she can immediately perform substitutive authentication and receive the virtual print service when the result of the substitutive authentication is OK.
(A-3) Effect of First Embodiment

According to the present embodiment, even when the primary authentication cannot be performed because of loss of the ID output device 17, the user can immediately perform substitutive authentication and receive the virtual print service when the result of the substitutive authentication is OK so that usability and convenience are high.
(B) Second Embodiment

Hereinafter, the present embodiment will be described only in the difference from the first embodiment. Since when the ID output device 17 is lost, the third party's abuse of the device is expected, the user requires to connect with a contact address (a provider which operates the virtual print server 13 or a credit card company, for example) and to take some measures such as invalidation of the ID output device 17. However, when a plurality of contact addresses are present, it is not necessarily easy for general users (U1, for example) to appropriately know what to do and rapidly perform the action.

The present embodiment provides solving means for the problem which lacks in the first embodiment.
(B-1) Constitution of Second Embodiment

The present embodiment is substantially different from the first embodiment mainly in the internal constitution of the virtual print server and in that contact addresses are contained in the virtual print system.

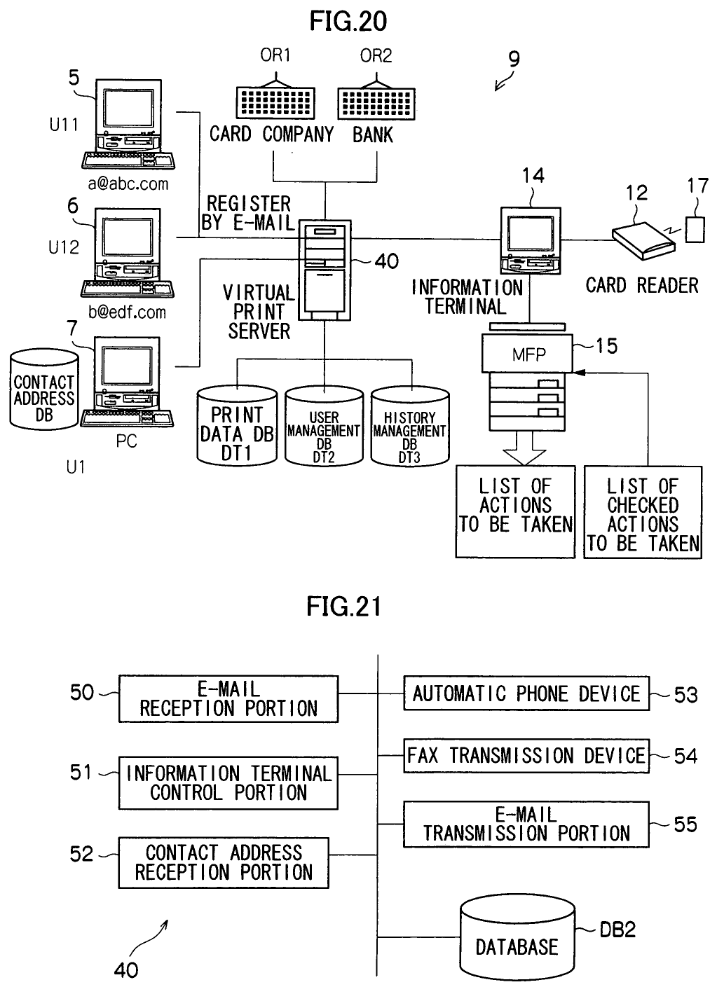

FIG. 20 shows an entire constitution example of a virtual print system 9 according to the present embodiment.

In FIG. 20, the functions of the components denoted with the same reference numerals 12, 14, 15, 17, DT1, DT2, and DT3 as in FIG. 3 correspond to those in the first embodiment, and thus detailed description thereof will be omitted.

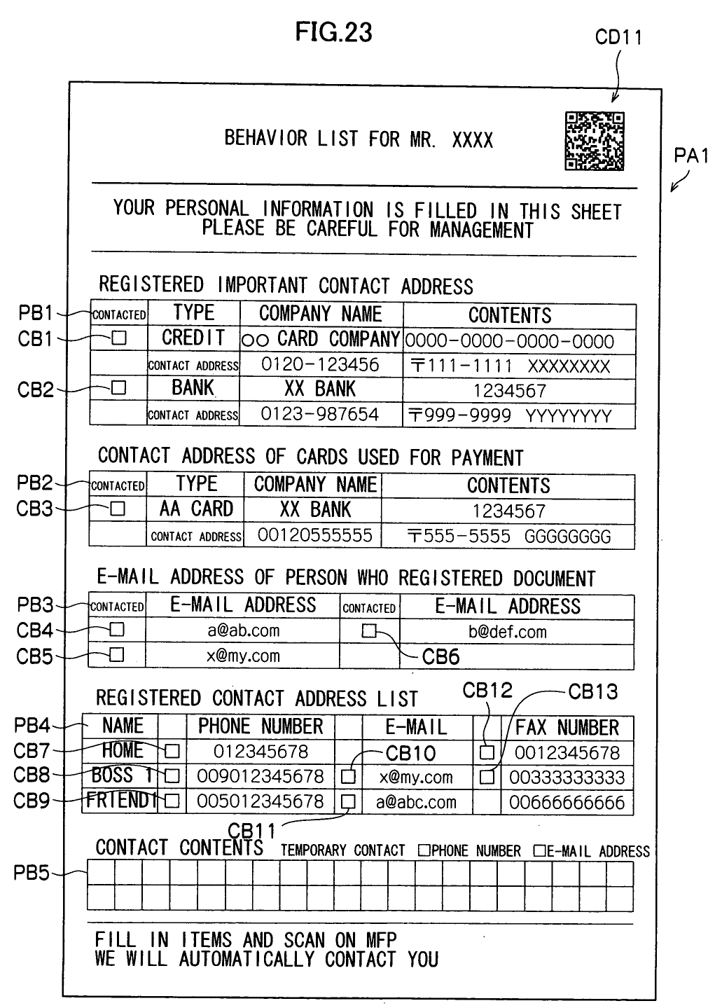

The MFP 15 in the present embodiment has a function of, when scanning a corresponding check box (CB3, for example) in a printed behavior list (behavior list PA1 shown in FIG. 23, for example), which is checked by the user U1, automatically connecting with a contact address corresponding to the check.

The reference numeral 12 in the present embodiment preferably denotes a card reader capable of reading personal information from a credit card or the like. However, whether it is the card reader or the ID reader 12 similar as in the first embodiment is only the difference of the communication specification of the physical layer described above in terms of communication, which is not an essential difference. Therefore, it is not an essential difference whether the ID output device 17 is a non-contact IC card which can communication without contact or a contact-type card which is mechanically mounted on a predetermined slot to perform reading.

A Card Company OR1 or bank OR2 is an example of the aforementioned contact address. A contact to the card company OR1 or bank OR2 may be made by mail, but it is preferably made by computer communication such as facsimile or e-mail since an immediacy is important for preventing abuse of the lost ID output device 17.

Personal computers 5 and 6 are also an example of the contact address. Connecting through computer communication is assumed with the emphasis on immediacy also in this case. When a personal computer is a destination, facsimile communication using VoIP technique may be employed, but e-mail is conveniently employed.

The personal computer 5 is used by a user U11, and the personal computer 6 is used by a user U12. The user U11 or U12 has registered contents in the virtual print server 13 for the user U1. When such registration by a user other than the content users is not permitted in the virtual print service, both the users U11 and U12 are assumed to be content users as the user U1, and when permitted, the users U11 and U12 does not necessarily need to be a member of the virtual print service.

When such content registration is performed, it is assumed that the user U1 and the users U11 and U12 are known each other so that contact to the personal computers 5 and 6 is made.

An internal constitution example of a virtual print server 40 according to the present embodiment is as shown in FIG. 18.

In FIG. 18, the functions of the components denoted with the same reference numerals 30 to 33 as in FIG. 1 correspond to those in the first embodiment, and thus detailed description thereof will be omitted.

A user behavior correspondence portion 41 in the virtual print server 40 is a component typical to the present embodiment, and the user behavior correspondence portion 41 performs generation of the behavior list PA1 shown in FIG. 23 or transmission to the MMK terminal 14 in response to a request from the user U1.

FIG. 21 shows a detailed constitution of part of the virtual print server 40.

In FIG. 21, the virtual print server 40 comprises an e-mail reception portion 50, an information terminal control device 51, a contact address reception portion 52, an automatic phone device 53, a FAX transmission device 54, and an e-mail transmission portion 55, and a database DB2.

The e-mail reception portion 50, the e-mail transmission portion 55, the FAX transmission device 54, and the automatic phone device 53 mainly correspond to the communication portion 30 in the virtual print server 40.

The e-mail transmission portion 55 transmits an e-mail, the FAX transmission device 54 transmits a facsimile, and the automatic phone device 53 automatically makes a call through synthetic voice, respectively, to connect with the aforementioned contact address.

The contact address reception portion 52 is contained in the user behavior correspondence portion 41 in the virtual print server 40 and receives the contact address. This reception is basically performed in response to an explicit request from the user U1, and may be automatically performed based on the user U1's use history of the virtual print service as needed.

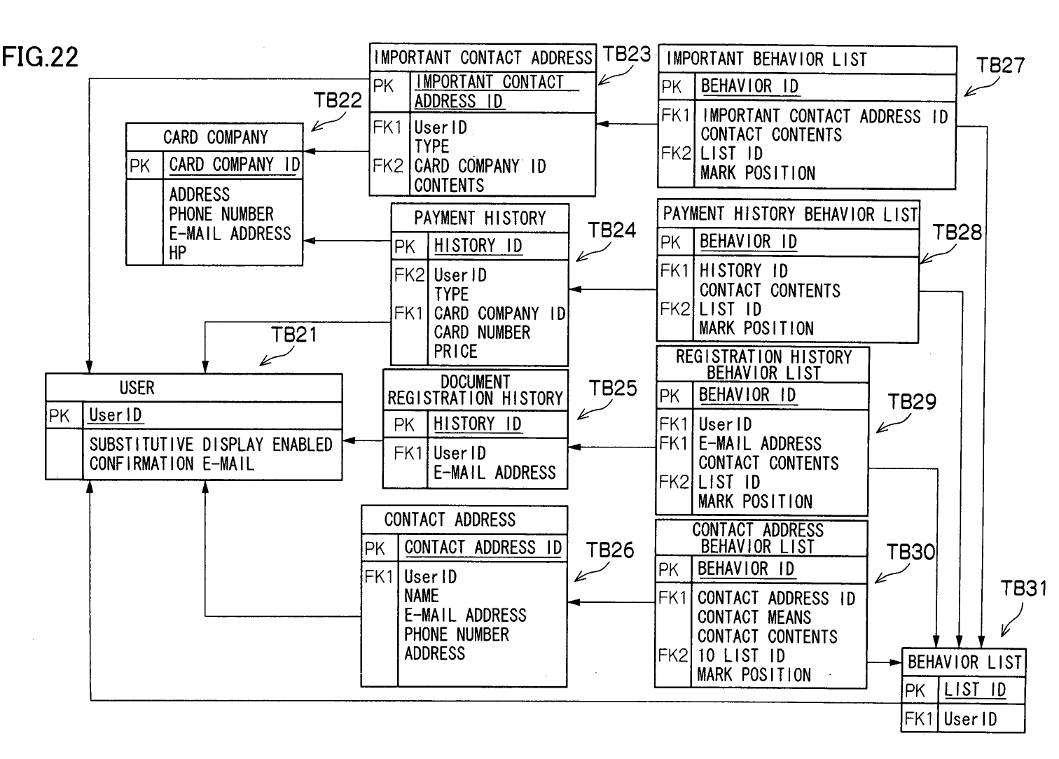

The database DB2 corresponds to the database DB1 in the first embodiment, and details thereof is as shown in FIG. 22.

FIG. 22 is an ER diagram in the same form as FIG. 4 used in the first embodiment.

FIG. 22 contains tables (relational tables) TB21 to TB31.

It is possible to specify information (address, phone number, e-mail address, HP(URL), and the like) required for contact to the card company by retrieving the card company table TB22, for example. In this case, HP is a data item which describes URL for contact when the card company uses a Web server to provide homepage for contact.

The important contact address table TB23 registers therein contact addresses important to the user U1 and is created by the user U1 using the Web page or the like provided by the virtual print server 40.

The contact address table TB26 registers therein contact addresses required for the user U1 and is created by the user U1 using the Web page or the like provided by the virtual print server 40 similarly as in the important contact address table TB23. As one example, the contents of the address book registered by the user U1 are uploaded on PIM software on a personal computer 7 so that the registration contents of the contact address table TB26 on the user U1 can be conveniently acquired.

The registration contents of the payment history table TB24 are automatically added when the user U1 utilizes the virtual print service or other service (credit card or the like).

The document registration history table TB25 is given e-mail addresses of users who have registered documents (content) by e-mail. It is possible to specify a user (U11, for example) who has registered the contents for the user U1 by checking this document history table TB25.

Further, it is possible to retrieve the registration contents of each table TB21 to TB30 on a certain user (U1, in this case) based on the user ID as an external key according to the behavior list table TB31.

Hereinafter, an operation of the present embodiment having the above constitution will be described with reference to flowcharts in FIGS. 25 to 27.

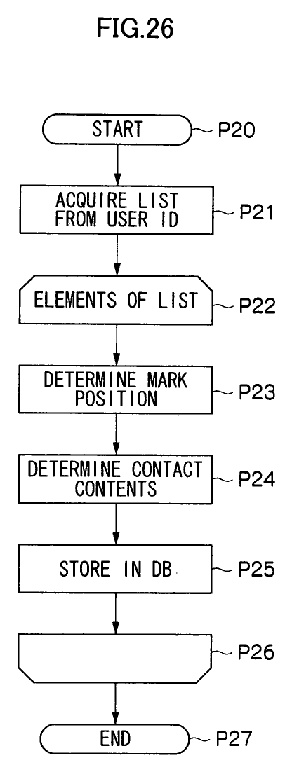

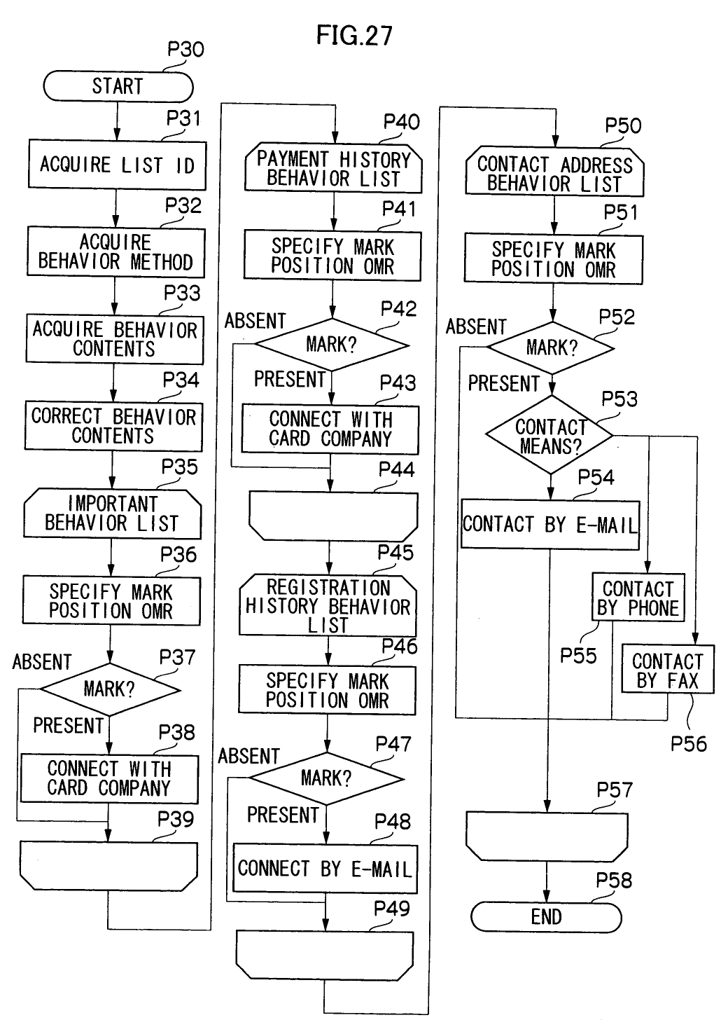

The flowchart in FIG. 25 is constituted of respective steps P10 to P19, the flowchart in FIG. 26 is constituted of respective steps P20 to P27, and the flowchart in FIG. 27 is constituted of respective steps P30 to P58.

The flowchart in FIG. 25 shows a processing flow when printing out the behavior list (PA1 in FIG. 23, for example), the flowchart in FIG. 26 shows a processing flow when generating an important behavior list or the like in the virtual print server 40, and the flowchart in FIG. 27 shows a processing flow when automatically connecting with a contact address.
(B-2) Operation of Second Embodiment

The flowchart in FIG. 25 is started when a printout request message for requesting to print out the behavior list reaches from the user U1. This printout request message can be constituted to be transmitted from the cellular phone 16 and is assumed to be transmitted from the MMK terminal 14 in this case. For example, when the ID output device 17 is lost, the user U1 transmits the printout request message. The provider which operates the virtual print server 40 and provides the virtual print service can recognize the loss of the ID output device 17 only by receiving such printout request message.

When such printout request message is received, the virtual print server 40 issues a list ID for printing out the behavior list PA1 (P11). This list ID at the time of issuance is text and then is converted to the QR code in order to arrange the text on the behavior list PA1 shown in FIG. 23 as the QR code CD11 (P12).

An important behavior list on the user U1, a payment history behavior list, a registration history behavior list, and a contact address behavior list are created in the subsequent steps P13 to P16, respectively.

The important behavior list is created based on the registration contents of the important behavior list table TB27, the payment history behavior list is created based on the registration contents of the payment history behavior list table TB28, the registration history behavior list is created based on the registration contents of the registration history behavior list table TB29, and the contact address behavior list is created based on the registration contents of the contact address behavior list table TB30. Details of these creating procedures will be described later.

When the behavior lists are created in steps P13 to P16, respectively, layouts thereof are determined in step P18.

Thereafter, the contents of each behavior list whose layout has been determined are transmitted from the virtual print server 40 to the MMK terminal 14 and printed out from the MFP 15 via the MMK terminal 14. In this case, the aforementioned behavior list PA1 in FIG. 23, for example, is printed out.

FIG. 26 shows a detailed procedure of creating each behavior list. The procedures of creating the important behavior list, the payment history behavior list, the registration history behavior list, and the contact address behavior list are substantially identical to each other, and FIG. 26 will be described by way of example of the important behavior list.

In FIG. 26, initially the important behavior list is determined to be created, and the user ID is specified (P21).

Since when the user ID can be specified, one or more rows corresponding to the user ID are specified from the important contact address table TB23 so that a list composed of the rows (elements) can be acquired, subsequently an operation of determining a mark position for each row (P23), determining contact contents (P24), and storing it in a database is only repeated (P22 to P26). This database may be a table contained in part of the database DB2. The mark position is a position of the checkbox. It is detected whether or not this mark position is checked in scanning by the above MFP 15.

Details of a procedure of scanning the behavior list PA1 printed out from the MFP 15 and automatically transmitting it to the contact address by the MFP15 are as shown in FIG. 27. Prior to execution of the flowchart in FIG. 27, the user U1 checks a desired check box in the check boxes CB1 to CB13 on the behavior list PA1.

In FIG. 27, when the behavior list PA1 placed on the glass surface is scanned after checked, the MFP 15 initially decodes and acquires the list ID from the QR code CD 11 (P31), and acquires behavior method and behavior contents (P32, P33). The behavior method is a specific communication contact method such as facsimile or e-mail. The behavior contents are a communication destination by the contact method (facsimile number or destination e-mail address, for example).

When the behavior contents are constituted to be appropriately corrected, if correction is required, the user U1 can screen-display the contents of the behavior list PA1 on the MMK terminal 14 before printout to correct the contents by edition (P34).

Though each table PB1 to PB5 on the behavior list PA1 may be processed in any order, since strictly the earlier the processing is performed the earlier the execution of the contact is, it is better to process in descending order of influence when the lost ID output device 17 is abused. In the flowchart in FIG. 27, the important behavior list is first processed after scanned. The important behavior list is the table PB1 on the behavior list PA1 (P35).

In the processing of the important behavior list, the mark positions in the table PB1 (that is, positions of the check boxes CB1 and CB2) are specified, and whether the boxes are checked (marked) is determined by the OMR (P36). When neither check box is checked, the processing on the table PB1 is terminated. However, when checked, a contact address (corresponding card company, for example) corresponding to the check box is connected (P38).

Subsequently, the payment history behavior list (table PB2) in steps P40 to P44, the registration history behavior list (table PB3) in steps P45 to P49, and the contact address behavior list (table PB4) in steps P50 to P57 are similarly processed, and details thereof are substantially similar as in the important behavior list and are different in that when checked the contact address is connected and when not checked the contact address is not connected, and thus detailed description thereof will be omitted.

However, since the table TB4 corresponding to the contact addresses behavior list has more contact means than other table (PB1, for example), the user can select one of the three brunches (e-mail (P54), phone (P55), and facsimile (FAX) (P56)) in step S53.

Although the behavior list PA1 is constituted to be printed out in this case, there may be constituted so that the user U1 performs an operation corresponding to the checking of the check boxes using the edition function of the MMK terminal 14 instead of printing out and the MFP 15 or the MMK terminal 14 connects with each contact address in response to the result.

Although the behavior list PA1 describes therein much personal information on the user U1 so that a disposal of the scanned behavior list PA1 needs to be considered in order to prevent leakage of the personal information, if printout is not performed, such leakage can be eliminated.
(B-3) Effect of Second Embodiment

According to the present embodiment, effects similar to those in the first embodiment can be obtained.

In addition, in the present embodiment, even when the ID output device 17 is lost, the user U1 can appropriately know what to do and can rapidly perform the action with a remarkably small number of steps so that convenience is high and security performance is improved.
(C) Third embodiment

Hereinafter, the third embodiment will be described only in the difference from the first and second embodiments.

After the lost ID output device 17 is invalidated, for example, after the user ID or password output from the ID output device 17 is invalidated, when the ID output device 17 returns back to the user U1, there is a high possibility of requiring a processing where the effectiveness of the ID output device 17 is recovered and the user ID or password is validated (that is, resumption processing). However, it is not necessarily easy for a general user (U1, for example) to efficiently perform such complicated procedure required for the processing.

The present embodiment provides solving means for the problem which lacks in the first and second embodiments.
(C-1) Constitution and Operation of Third Embodiment

The present embodiment is different from the second embodiment only in an internal constitution of a virtual print server. The internal constitution of a virtual print server 50 according to the present embodiment is as shown in FIG. 19.

In FIG. 19, the functions of the respective components denoted with the same reference numerals 30 to 34 and 41 as in FIG. 18 are identical to those in the second embodiment, and thus detailed description thereof will be omitted.

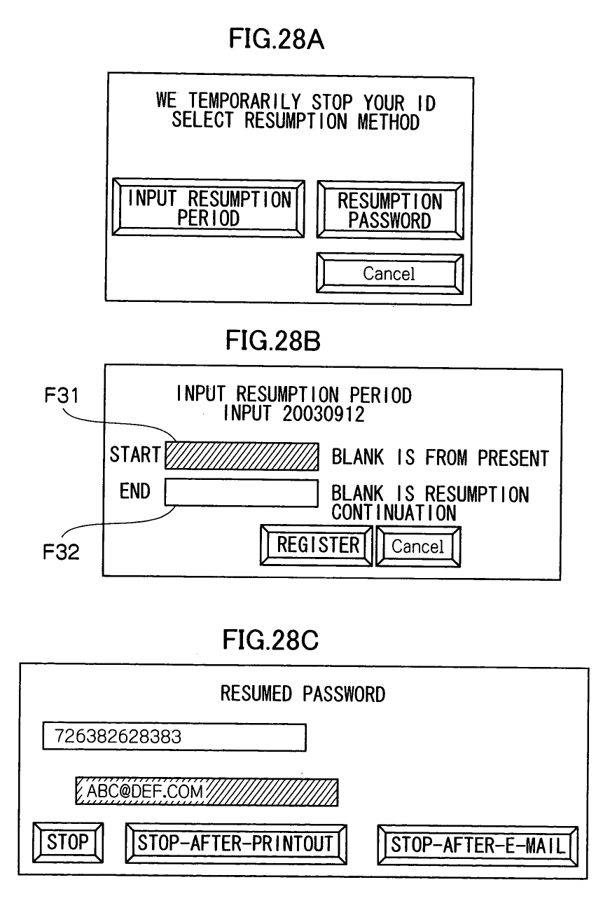

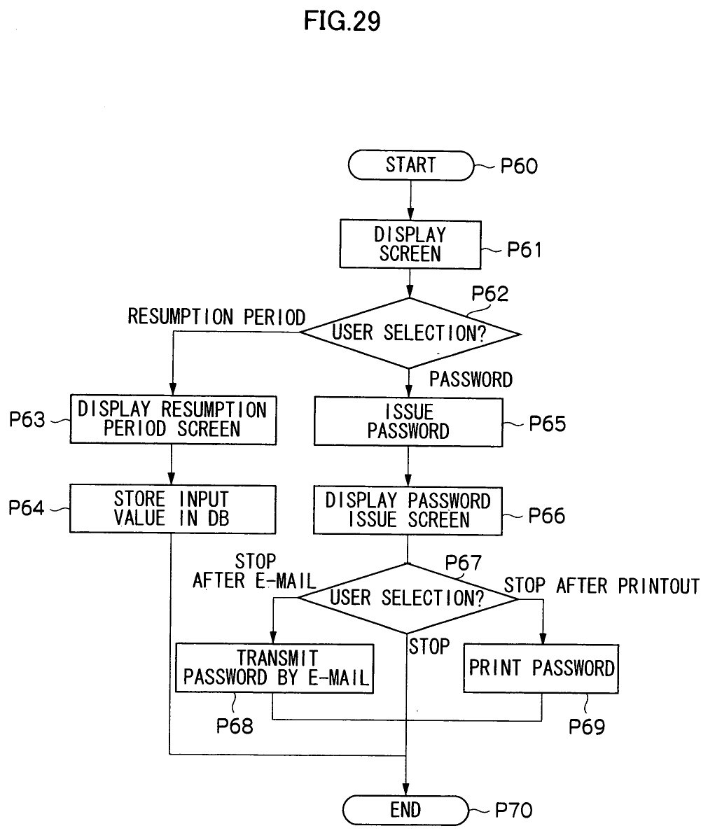

A resumption processing portion 51 in the virtual print server 50 is a component typical to the present embodiment, and an operation in FIG. 28 or 29 described later is realized mainly by the function of the resumption processing portion 51.

A flowchart in FIG. 29 is constituted of respective steps P60 to P70, and shows a processing of determining conditions for starting the aforementioned resumption processing.

In FIG. 29, a selection screen of the resumption method (screen shown in FIG. 28A, for example) is displayed on the MMK terminal 14 to cause the user U1 to select a condition (resumption method) of starting the resumption processing (P61, P62). In the example in FIG. 28A, a resumption period and a resumption password (password for resumption) are prepared as the resumption method. The resumption processing is automatically started when the resumption period previously designated by the user U1 has elapsed, and the user U1 can start the resumption processing any time by inputting the resumption password.

When the user U1 presses a resumption period input button on FIG. 28A, the processing proceeds to step P63 and the display screen transits to a screen shown in FIG. 28B. A field F31 for inputting a date when the resumption processing is started is prepared on the screen in FIG. 28B. A field F32 is also provided on the screen for designating a date when the user ID or password whose effectiveness is recovered by the resumption processing is invalidated again though the resumption processing is considered to be rarely used because of the nature thereof.

The filled-in contents of these fields F31 and F32 are registered and stored in the database in the form of being corresponded to the IDU1 which is the user ID of the user U1 in the virtual print server 50. However, since almost all the data on the user U1 is registered and managed in the virtual print server 50 in a correspondence manner based on the user ID even after the user ID is invalidated, the value of the user ID naturally needs to be stored. The invalidation of the user ID means that negative correspondence such as refusal is made to an access when the access using the user ID is tried to the virtual print server 50 from outside.

On the other hand, when the resumption password is selected in the step P62, that is, when the user U1 presses a resumption password button on the screen in FIG. 28A, the resumption processing portion 51 in the virtual print server 50 issues a resumption password (P56) and the resumption password is transmitted to the user U1 via the screen shown in FIG. 28C, for example. However, this resumption password may be described or selected by the user U1 instead of being issued from the virtual print server 50.

In either case, the contents of the resumption password need to be stored in the database in the virtual print server 50.

When the user U1 presses a stop-after-e-mail button on the screen in FIG. 28C, the resumption password is described in an e-mail and transmitted to the personal computer (7, for example) or the cellular phone 16 of the user U1 (P68), and when the stop-after-printout button is pressed, the password is printed out from the MFP 15 or a receipt printer (not shown) (P69). Such e-mail or printout is effective such that the user U1 can surely store the contents of this resumption password and reuse it when he/she desires to start the resumption processing.

However, since when the user U1 can surely memorize the password by heart, the password does not need to be stored, the user U1 can press the stop button on the screen in FIG. 28C to terminate the flowchart in FIG. 29. The user U1 memorizes the password by heart so that a possibility where the password is known to the third party is lowest and security performance is high.

As described above, when the user U1 selects the resumption date as the resumption method through the selection in the step P62, the virtual print server 50 automatically starts the resumption processing when the resumption period previously designated by the user U1 has elapsed. When the user selects the resumption password as the resumption method, the user U1 can start the resumption processing any time by inputting the resumption password from the MMK terminal 14, for example, and transmitting it to the virtual print server 50.
(C-2) Effect of Third Embodiment

According to the present embodiment, effects similar to those in the second embodiment can be obtained.

In addition, in the present embodiment, the resumption processing can be remarkably efficiently started so that the trouble of an operation on the user is small.

For example, when the resumption date is selected as the resumption method, even when the user U1 does not perform a special procedure, the resumption processing automatically starts after the resumption date has passed. When the resumption password is selected as the resumption method, the user U1 can start the resumption processing at a desired timing only by inputting the resumption password.
(D) Other Embodiment

Although the first to third embodiments target content users (that is, users), the present invention can target content providers.

This is because the non-contact IC card and the like can be utilized also for managing the content providers.

It is natural that the characteristics of each embodiment can be combined in a combination other than the first to third embodiments. For example, it is possible to constitute a virtual print server which has the resumption processing portion 51 instead of the user behavior correspondence portion 41.

The cellular phone 16, for example, may be employed as the ID output device 17. This is because the cellular phone 16 mounts thereon an infrared communication function or short distance wireless communication function so that personal information can be sent to the ID reader 12 via such function.

The present invention is mainly realized in hardware in the above description, but the present invention can be realized also in software.

It is natural that a program having the function such as the virtual print server described above can be stored in a storage medium (CD-ROM, for example).

1. An information storage server which, when providing a service of storing contents designated by a user in a content storage portion and transmitting the contents to a content output terminal in response to an output request from the user, performs authentication based on authentication information notified by the user's using a predetermined main authentication information notification function through a predetermined procedure, and provides the contents to the user via the content output terminal when an affirmative authentication result is obtained,
the information storage server comprising a substitutive authentication reception portion which receives authentication by a substitutive authentication information notification function in which at least one of the authentication information itself and the using procedure is different from the main authentication information notification function, when the main authentication information notification function is in a unusable state.

2. An information storage server according to claim 1, comprising:
a correspondence behavior storage portion for storing correspondence behavior instruction information indicating an action to be performed by the user for a detailed form in the unusable state; and
a correspondence behavior instruction portion for, when the user uses the content output terminal or other communication terminal to notify that the authentication information notification function is in a unusable state, returning the correspondence behavior instruction information.

3. An information storage server according to claim 1, comprising an authentication access control portion for, when the main authentication information notification function is in a unusable state and authentication by the main authentication information notification function is prohibited in response to an instruction from the user, releasing the prohibition when a predetermined release condition is satisfied.

4. An information storage program which, when providing a service of storing contents designated by a user in a content storage portion and transmitting the contents to a content output terminal in response to an output request from the user, performs authentication based on authentication information notified by the user's using a predetermined main authentication information notification function through a predetermined procedure, and provides the contents to the user via the content output terminal when an affirmative authentication result is obtained,
the information storage program causing a computer to realize a substitutive authentication reception function which receives authentication by a substitutive authentication information notification function in which at least one of the authentication information itself and the using procedure is different from the main authentication information notification function, when the main authentication information notification function is in a unusable state.

5. An information storage program according to claim 4, which causes a computer to realize:
a correspondence behavior storage function of storing correspondence behavior instruction information indicating an action to be performed by the user for a detailed form of the unusable state; and
a correspondence behavior instruction function of, when the user uses the content output terminal or other communication terminal to notify that the authentication information notification function is in a unusable state, returning the correspondence behavior instruction information.
